(19) United States
(12) Patent Application Publication
(10) Pub. No.: US 2021/0312830 A1
(43) Pub. Date: Oct. 7, 2021

(54) SERVER DEVICE, ELECTRONIC DEVICE, AND METHOD FOR CONTROLLING OUTPUT CONTROL INFORMATION FOR RECIPE INFORMATION

(71) Applicant: Cookpad Inc., Tokyo (JP)

(72) Inventors: Shinya OHTANI, Tokyo (JP); Masayuki IOKI, Tokyo (JP); Akihisa KANEKO, Tokyo (JP); Tomomichi SUMI, Tokyo (JP); Jun HARASHIMA, Tokyo (JP)

(73) Assignee: Cookpad Inc., Tokyo (JP)

(21) Appl. No.: 17/352,366

(22) Filed: Jun. 21, 2021

Related U.S. Application Data
(63) Continuation of application No. PCT/JP2018/047658, filed on Dec. 25, 2018.

(51) Int. Cl. G09B 19/00; G06F 16/903; G09B 5/04; G09B 5/02

(52) U.S. Cl. CPC G09B 19/003; G09B 5/02; G09B 5/04; G06F 16/90335

(57) ABSTRACT

A server device includes a memory that stores recipe information, and circuitry. The circuitry is configured to transmit, via a network, the recipe information to a terminal device; receive, via the network, user attribute information regarding an attribute of a user of the terminal device; receive, via the network, information regarding an information output mode available by the terminal device or a cooking appliance device; and perform control for outputting the recipe information by at least one of the terminal device or the cooking appliance device, based on the received information regarding the information output mode and the received user attribute information, the recipe information being output, by the cooking appliance device or the terminal device, in an output mode that matches the attribute of the user indicated by the user attribute information.

### CROSS-REFERENCE TO RELATED APPLICATION

This application is a continuation of International Patent Application No. PCT/JP2018/047658, filed on Dec. 25, 2018, which is incorporated by reference herein in its entirety.

### TECHNICAL FIELD

The present disclosure relates to a server device, an information processing terminal, a system, a method, and a program that enable outputting a recipe in a manner suitable for attributes of a device and a user.

### BACKGROUND

A variety of recipes have recently been provided through the Internet, television, and magazines. Such recipes, describing a sequence of cooking steps, can be used by users in general. For example, Patent Literature 1 discloses a method in which a host device storing pieces of cooking recipe data provides, over a communication network, cooking recipe data resulting from a search requested by a user.

A recipe obtained as above is typically used by simply displaying the recipe on a user's device such as a PC. Meanwhile, there are needs of users who are busy with childcare or other housework, desiring to know recipes in the form of speech, virtual reality (VR), or augmented reality (AR). For example, Patent Literature 2 discloses a method of obtaining information about food, cooking, or health over the Internet and outputting the information in the form such as text, speech, or video.

### CITATION LIST

### Patent Literature

Patent Literature 1: Japanese Patent Laid-Open No. 2002-063178

Patent Literature 2: Japanese Patent Laid-Open No. 2001-248955

### SUMMARY

The present disclosure provides a server device which includes a memory that stores recipe information, and circuitry. The circuitry is transmit, via a network, the recipe information to a terminal device; receive, via the network, user attribute information regarding an attribute of a user of the terminal device; receive, via the network, information regarding an information output mode available by the terminal device or a cooking appliance device; and perform control for outputting the recipe information by at least one of the terminal device or the cooking appliance device, based on the received information regarding the information output mode and the received user attribute information, the recipe information being output, by the cooking appliance device or the terminal device, in an output mode that matches the attribute of the user indicated by the user attribute information.

### BRIEF DESCRIPTION OF THE DRAWINGS

FIG. 1 is a diagram illustrating the data structure of output control information in an embodiment.

FIG. 2 is a configuration diagram of a recipe output control system 1 in the embodiment.

FIG. 3 is a block diagram illustrating an exemplary hardware configuration in the embodiment.

FIG. 4 is a diagram illustrating the functional block configuration of a terminal device 200 in the embodiment.

FIG. 5 is a diagram illustrating an exemplary configuration of specifications information in the embodiment.

FIG. 6 is a diagram illustrating an exemplary configuration of user information in the embodiment.

FIG. 7 is a diagram illustrating the functional block configuration of a recipe output control server 300 in the embodiment.

FIG. 8 is a diagram illustrating an exemplary configuration of a recipe information DB in the embodiment.

FIG. 9 is a diagram illustrating an exemplary configuration of a determination rule DB in the embodiment.

FIG. 10 is a diagram illustrating an exemplary configuration of an expression DB in the embodiment.

FIG. 11 is a diagram illustrating the functional block diagram of an appliance 100 in the embodiment.

FIG. 12 is a diagram illustrating exemplary operations of the recipe output control system 1 in the embodiment.

### DETAILED DESCRIPTION OF THE DRAWINGS

As described in Patent Literature 2, outputting text information in speech form through what is called a smart home appliance or a smart speaker, or through a mobile terminal, has been conventionally performed.

Unfortunately, recipes are usually written to be viewed in normal text form. Outputting such recipes in speech, VR, or AR form does not well match the human perception, thinking speed, and senses, thus often preventing the user's clear understanding of the content of the recipes.

The above problem may be further worsened by attributes of a device that outputs recipes, or by attributes of the user of the device. For example, each output device has a different operating system (OS) and a different engine, such as a morphological analysis engine, a speech synthesis engine, or a rendering output engine. Each output device therefore has different accuracy and peculiarity in recognizing words and clauses, and a different output tempo such as speech tempo. Each user often has different information recognition speed and accuracy due to the user's age and cooking skill.

As such, when a device designed to output recipes in a form that prevents clear understanding by a user having certain attributes is used, simply outputting (e.g., reading) a recipe further increases the user's difficulty in understanding the recipe. The inventors of the present disclosure have developed technology addressing these issues.

To accomplish the above object, a server device according to the present disclosure includes: a recipe information storage unit that stores recipe information; and a control information generation unit that generates, based on information about a user using the recipe information and based on information about a device used by the user, output control information for the recipe information by the device used, the output control information being generated to match the user's attribute.

To accomplish the above object, an information processing terminal according to the present disclosure includes: an information obtainment unit that obtains the output control information from the server device; and an output unit that outputs the recipe information according to the output control information.

To accomplish the above object, a system according to the present disclosure includes a server device including: a recipe information storage unit that stores recipe information; and a control information generation unit that generates, based on information about a user using the recipe information and based on information about a device used by the user, output control information for the recipe information by the device used, the output control information being generated to match the user's attribute. The system also includes an information processing terminal including: an information obtainment unit that obtains the output control information from the server device; and an output unit that outputs the recipe information according to the output control information.

To accomplish the above object, a method according to the present disclosure includes the steps of: storing recipe information in a recipe information storage unit; and generating, based on information about a user using the recipe information and based on information about a device used by the user, output control information for the recipe information by the device used, the output control information being generated to match the user's attribute.

To accomplish the above object, a program according to the present disclosure causes a computer to perform the above method.

In view of the above circumstances, an object of the present disclosure is to provide a server device, an information processing terminal, a system, a method, and a program that enable outputting a recipe in a manner suitable for attributes of a device and a user. The present disclosure enables outputting a recipe in a manner suitable for attributes of a device and a user. Further features of the present disclosure will become apparent from the following description of exemplary embodiments with reference to the attached drawings.

An embodiment of the present disclosure will be described below with reference to the drawings. Throughout the drawings illustrating the embodiment, like elements are given like symbols and will not be described repeatedly. The embodiment below is not intended to unnecessarily limit the scope of the present disclosure set forth in the claims. Not all of the elements illustrated in the embodiment are essential for the present disclosure.

### Overview of Embodiment

A recipe output control system according to the embodiment refers to attributes of a device, such as an oven, a microwave oven, a refrigerator, or a mobile terminal like a smartphone, and attributes of the user of the device, thereby enabling a recipe to be output in a manner (e.g., at a tempo) suitable for the user's understanding.

Recipe information in the embodiment may include both recipe information that quantitatively describes cooking details and recipe information that qualitatively describes cooking details.

Recipe information, whichever type it is, needs to include expressions that describe the operations of a cooking process in words so that a person who receives the output, such as speech output, of the recipe information can understand the recipe information. Recipe information preferably includes quantitative expressions for uniform understanding by different persons, or for enabling the above device functioning as a cooking appliance to perform cooking operations according to the recipe information.

Recipe information described only qualitatively includes expressions in which operations and the states of ingredients in a cooking process are represented without numerical values such as amounts, temperatures, and durations. Specifically, such expressions may be “cook the meat until aromatic,” “a little salt,” and “boil the potatoes until a wooden pick can be inserted smoothly into them.”

If recipe information that includes only such qualitative expressions is output in speech form, a user who listens to the speech can understand what the recipe means if the user has a sufficiently high cooking skill. A user with a poor cooking skill, however, may not be able to correctly understand the indefinitely described recipe and may fail to start cooking actions.

By contrast, recipe information that appropriately includes quantitative expressions describes operations of a cooking process using specific numerical values. More specifically, quantitative expressions are used in descriptions such as “bake the meat for 20 minutes in the oven preheated to 200 degrees Celsius,” “3 grams of salt,” and “microwave the potatoes for 5 minutes at 600 W.” Quantitative expressions use specific numerical values to convey the details of operations performed with cooking appliances (tools), and are therefore suitable for controlling cooking appliances.

A variety of recipes have recently been provided through the Internet, television, and magazines. Such recipes, describing a sequence of cooking steps, can be used by users in general.

A recipe obtained as above is typically used by simply displaying the recipe on a user's device such as a PC. Meanwhile, there are needs of users who are busy with childcare or other housework, desiring to know recipes in the form of speech, virtual reality (VR), or augmented reality (AR).

Outputting text information in speech form through what is called a smart home appliance or a smart speaker, or through a mobile terminal, has been conventionally performed.

Unfortunately, recipes are usually written to be viewed in normal text form. Outputting such recipes in speech, VR, or AR form does not well match the human perception, thinking speed, and senses, thus often preventing the user's clear understanding of the content of the recipes.

The above problem may be further worsened by attributes of a device that outputs recipes, or by attributes of the user of the device. For example, each output device has a different operating system (OS) and a different engine such as a morphological analysis engine, a speech synthesis engine, or a rendering output engine. Each output device therefore has different accuracy and peculiarity in recognizing words and clauses, and a different output tempo such as speech tempo. Each user often has different information recognition speed and accuracy due to the user's age and cooking skill.

As such, when a device designed to output recipes in a form that prevents clear understanding by a user having certain attributes is used, simply outputting (e.g., reading) a recipe further increases the user's difficulty in understanding the recipe.

To address this, the recipe output control system according to the embodiment generates and uses output control information for recipe information at a tempo suitable for the user's information recognition ability. This is done based on the information output tempo of a device such as an oven, a microwave oven, a refrigerator, or a mobile terminal, and based on the information recognition ability of the user of the device that depends on the cooking skill, the age and the like of the user. Thus, the recipe output control system appropriately addresses different devices used by different users, or addresses different users having different levels of understanding due to their cooking skill or age. This enables the output, such as speech output, of recipe information in a manner (e.g., at a tempo) that facilitates each user's understanding.

### <Output Control Information>

Exemplary output control information contemplated according to the embodiment is recipe information including a sequence of cooking steps and interpretable by a cooking appliance, that is, quantitatively described recipe information. A device to be controlled according to the recipe information is a device associated with ingredients of a dish or with cooking performed using the ingredients (including a device that simply outputs information).

Given the output control information, a cooking appliance performs actions (processing) according to the output control information. Output control information readable and interpretable by a cooking appliance will herein be referred to as a machine-readable recipe (MRR).

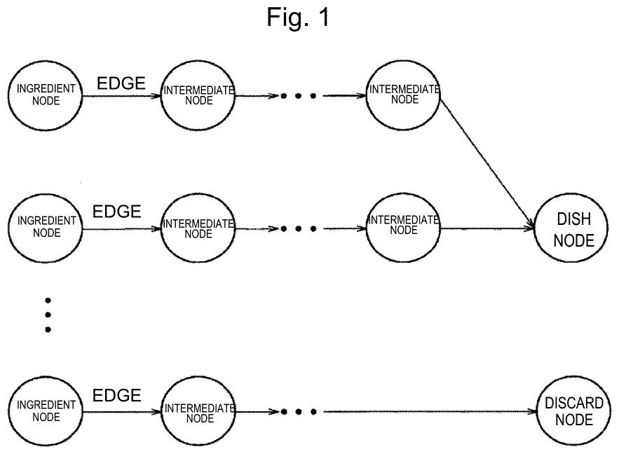

FIG. 1 is a diagram illustrating the data structure of output control information according to the embodiment. As shown in FIG. 1, the output control information, which is an MRR, according to the embodiment is represented as a graph (directed graph) that includes nodes and edges between the nodes. In FIG. 1, circles represent nodes, and arrows represent edges.

The nodes define the transitional states of ingredients. Each edge represents an action necessary for state transition between nodes. An action refers to a basic step of cooking, for example a step such as “cut” or “heat.” An action may include a specific set temperature and cooking time of an appliance, and the details of an operation. Action types and their IDs may be predetermined, or action types may be given their IDs later. A list of actions and their IDs is defined, and each edge is assigned an action ID selected from the list. Each state (intermediate node) may also be assigned an ID.

The nodes in the graph include: ingredient nodes that serve as start points of the graph and represent the ingredients of a dish to be made; a dish node that serves as the end point of the graph and represents the dish; and intermediate nodes that represent the states of the ingredients in the process leading to the dish.

The ingredients refer to food materials for making the dish and may include seasonings and discarded materials to be discarded during the cooking. Ingredient types and their IDs are predetermined. A list of ingredients and their IDs is defined, and each ingredient node is assigned an ingredient ID selected from the list.

The state of an ingredient refers to the state of the ingredient subjected to an action. For example, the state of an ingredient may be “an ingredient A cut into three equal pieces,” “an ingredient B cut into 3-cm dices,” or “an ingredient C heated.”

As above, the data structure of the output control information according to the embodiment represents the state transitions of the ingredients as a graph, rather than representing recipe sentences written in a natural language directly as a graph.

Each ingredient is assigned an ingredient ID that uniquely identifies the ingredient. Each action required for state transition is assigned an action ID that uniquely identifies the action. This allows ready and reliable machine interpretation of the recipe information based on the IDs.

Because the recipe information does not necessarily have to specify an appliance that is to perform each action, the recipe information can readily support various appliances, including appliances that will emerge in the future. Further, because all actions are represented as edges, actions can be readily extracted from the recipe information.

A partial graph is obtained by removing some edges and further removing some isolated nodes from the graph as shown in FIG. 1. Such a partial graph can be regarded as device control information for a cooking subprocess performed by controlling a particular cooking appliance in the sequential cooking process indicated by the recipe information.

Such device control information may serve as the above-described output control information, that is, information for controlling the output, such as speech output, of the cooking details in a manner (e.g., at a tempo) suitable for attributes of the device and the user. Thus, device control information for a cooking subprocess to be performed by a particular cooking appliance, in the cooking process of the entire recipe information, may be represented by a partial graph as output control information.

Table 1 illustrates node types in output control information according to the embodiment.

TABLE 1

| Node type | Description |
|---|---|
| Ingredient | A node representing an ingredient of a dish and serving |
| node | as a start point of a graph. The node requires an |
| | ingredient ID. |
| Intermediate | A node having IN and OUT edges and representing an |
| node | intermediate state of a dish. |
| Discard | A node representing an object such as skin peeled off. |
| node | The node is a terminal node but does not represent a |
| | dish. |
| Dish node | A terminal node representing a dish. |
| Special node | A supplementary node for an appliance, representing |
| | details such as preheating an oven. |

Each node can be assigned node attributes, for example those shown in Table 2. The example here assumes that the node is an ingredient node representing “carrot.”

TABLE 2

| Node attribute | Example |
|---|---|
| State | Raw |
| Name | Carrot (or Ingredient ID) |
| Amount | The amount (weight) of the ingredient |
| Output speed | 75 words/minute |
| Output standby time | 2 seconds |

“Name” is information needed by a human to create or interpret an MRR and does not necessarily have to be machine-readable.

Each node in the embodiment is assigned the attributes of the output speed (e.g., the reading speed) and the output standby time. These attributes are used to output (e.g., read) information, such as the “name” and the “amount,” in the node.

The output standby time is the standby time between the completion of outputting, such as reading, each node and the start of outputting, such as reading, an edge connecting to the node in the graph. The nodes are controlled to be output according to these attributes.

Each edge can be assigned edge attributes such as those shown in Table 3. As shown in the example in Table 3, as with the nodes, each edge is assigned the attributes of the output speed and the output standby time.

TABLE 3

| Edge attribute | Description |
|---|---|
| Name | An action name such as “cut” or “heat.” |
| Action ID | An ID corresponding to the action name. |
| Termination | The condition for terminating the action, such as |
| condition | cutting into “3-cm dicesv or simmering for “5 |
| | minutes.” |
| Appliance ID | An ID representing an appliance such as “oven” |
| | or “microwave oven.” |
| Position in the | A number representing the position in the order |
| edge order | of performing actions. |
| Output speed | 75 words/minute |
| Output standby time | 5 minutes |

The following description takes specific examples of nodes. In making a dish “salad,” the dish node is “salad.” The ingredient nodes are, for example, “onion,” “cucumber,” “tomato,” “ketchup,” and “mayonnaise.” Each ingredient node is assigned an ID that uniquely identifies the ingredient.

As in the examples in above Tables 2 and 3, each node has the output speed set to 75 words/minute, and the output standby time set to 2 seconds. Each edge has the output speed set to 75 words/minute, and the output standby time set to 5 minutes.

The ingredient node “onion” is connected by an edge (action) “cut” to an intermediate node “chopped onion.” The ingredient node “cucumber” is connected by an edge (action) “cut” to an intermediate node “1-cm diced cucumber”.

Further, the ingredient node “tomato” is connected by an edge (action) “cut” to an intermediate node “halved tomato”. Still further, the ingredient nodes “ketchup” and “mayonnaise” are each connected by an edge (action) “mix” to an intermediate node “aurora sauce.” Each of the actions “cut” and “mix” is assigned an ID that uniquely identifies the action.

The intermediate nodes “chopped onion,” “1-cm diced cucumber,” and “halved tomato” are each connected by an edge (action) “arrange on a plate” to the dish node “salad.”

The intermediate node “aurora sauce” is connected by an edge (action) “put on” to the dish node “salad.” Each of the actions “arrange on a plate” and “put on” are assigned an ID that uniquely identifies the action. The edges are ordered so that “put on” comes after “arrange on a plate.” The action “put on” may be replaced with an action “mix with.”

Output control information in MRR form configured as above may be used to control the output, for example speech output, of the MRR in the following manner. For example, an ingredient node is read as “onion' half wo” at a speed of 75 words/minute. After two seconds of standby time, an edge (action) connecting to the ingredient node is read as “‘cut’ suru” at a speed of 75 words/minute. After the following 5 minutes of output standby time, an intermediate node is read as “Now you have ‘chopped onion’” at a speed of 75 words/minute.

### <Description of Embodiment>

The embodiment of the recipe output control system that uses the above-described data structure will be described.

### (Configuration of Recipe Output Control System 1)

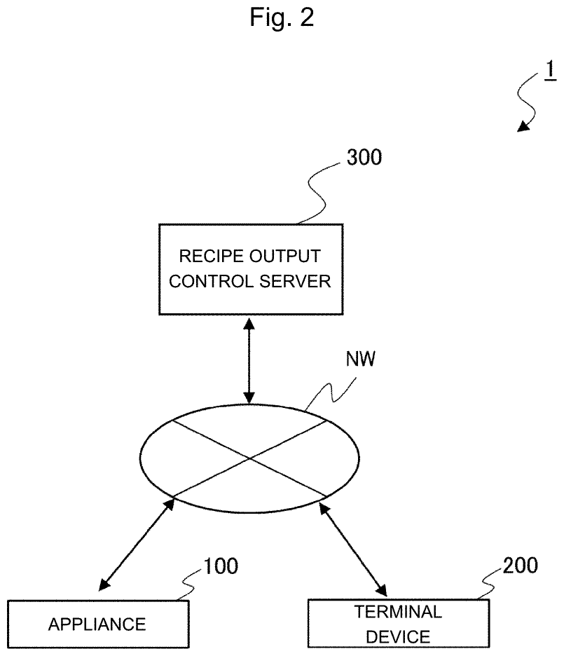

FIG. 2 is a configuration diagram of a recipe output control system 1. The configuration of the recipe output control system 1 will be described with reference to FIG. 2.

The recipe output control system 1 includes an appliance 100, a terminal device 200, and a recipe output control server 300, which are communicatively interconnected over a network NW. The network NW may include a wide area network (WAN) and a local area network (LAN). The appliance 100 may bypass the network NW and directly communicate with the terminal device 200 (e.g., through short-range wireless communication). Although one appliance 100 and one terminal device 200 are representatively shown in FIG. 2, multiple appliances 100 and multiple terminal devices 200 may be connected to the network NW.

The appliance 100, having a communication function, is located in a kitchen and associated with ingredients of a dish or with cooking performed using the ingredients. The appliance 100 may be a consumer electronic appliance used at home, or an appliance for professional use.

The appliance 100 may be any appliance located in a kitchen and associated with ingredients or with cooking performed using the ingredients. For example, the appliance 100 may be a refrigerator, a microwave oven, an oven, an induction cooker, a toaster oven, a food processor, a mixer, a rice cooker, an electric pot, an electric fryer, an electric steamer, a noodle maker, a kitchen scale, a cooking robot, a gas cooker, or lighting equipment.

The appliance 100 receives output control information as described above from the recipe output control server 300 and accordingly performs the output, such as speech output, of recipe information for presentation to the user.

The terminal device 200, having a communication function, provides a user interface. In response to the user's operation, the terminal device 200 posts (sends) recipe information (such as recipe text and dish image data) to the recipe output control server 300. The terminal device 200 also receives output control information as described above from the recipe output control server 300 and accordingly performs the output, such as speech output, of recipe information for presentation to the user.

The terminal device 200 is an information processing terminal, for example a mobile terminal (e.g., a tablet computer, a smartphone, a laptop computer, a feature phone, a portable gaming device, or an electronic book reader). The terminal device 200 may also be a television receiver (including an Internet television), a personal computer (PC), a virtual reality (VR) terminal, or an augmented reality (AR) terminal.

The recipe output control server 300 stores recipe information posted from the terminal device 200. Based on information about the user who uses the recipe information and information about the user's appliance 100 or terminal device 200, the recipe output control server 300 generates output control information for the recipe information by the appliance 100 or the terminal device 200; the output control information is generated to match the user's attributes.

The recipe output control server 300 sends the output control information generated to the terminal device 200 and/or the appliance 100. The output control information is machine-readable, having the above-described recipe data structure (see FIG. 1 and Tables 1 to 3). The recipe output control server 300 transmits the output control information to the terminal device 200 and/or the appliance 100 over the network NW.

The recipe output control server 300 collects, from the terminal device 200, attribute information such as the user's cooking skill and age. The recipe output control server 300 collects, from the appliance 100 or the terminal device 200, specifications information about the appliance 100 or the terminal device 200. The specifications information may indicate the operating system (OS), an engine such as a morphological analysis engine, a speech synthesis engine, or a rendering output engine, and the speech tempo.

In response to the transmission of the MRR, which is the above-described output control information, the appliance 100 starts actions according to the MRR. Alternatively, the user of the terminal device 200 performs an action start operation on the appliance 100 for causing the appliance 100 to start actions according to the MRR. For example, the appliance 100 or the terminal device 200 has a physical button for receiving an action start operation. The appliance 100 or the terminal device 200 may also have a software button displayed thereon for receiving an action start operation.

If the output control information is simply used for controlling the output of the recipe information in the terminal device 200 or the appliance 100 and is not used as an MRR for automatic cooking operations in the appliance 100, the above MRR-based actions in the appliance 100 may be omitted.

### (Hardware Configuration)

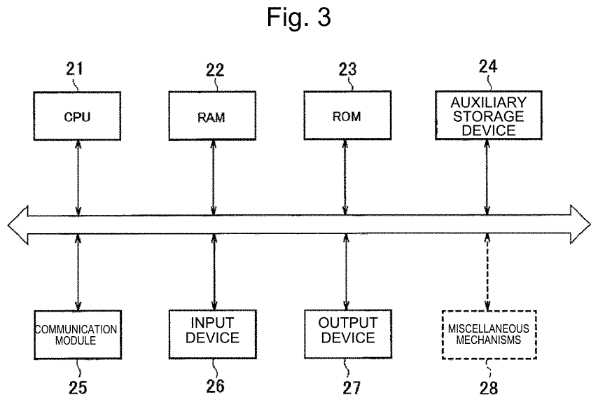

The hardware configuration of the appliances and devices in the recipe output control system 1 will be described. FIG. 3 is a block diagram illustrating an exemplary hardware configuration of each of the appliance 100, the terminal device 200, and the recipe output control server 300.

As shown in FIG. 3, each of the appliance 100, the terminal device 200, and the recipe output control server 300 includes a CPU 21, a RAM 22, a ROM 23, an auxiliary storage device 24, a communication module 25, an input device 26, and an output device 27. In an exemplary implementation, the appliance 100, the terminal device 200, and the recipe output control server 300, and any of the storage device 24, the communication module 25, the input device 26, and the output device 27 are implemented using circuitry or processing circuitry which includes general purpose processors, special purpose processors, integrated circuits, ASICs (“Application Specific Integrated Circuits”), CPU (a Central Processing Unit), a micro processing unit (MPU), conventional circuitry and/or combinations thereof which are configured or programmed to perform the disclosed functionality. Processors are considered processing circuitry or circuitry as they include transistors and other circuitry therein. The processor may be a programmed processor which executes a program stored in a memory. In the disclosure, the circuitry, units, or means are hardware that carry out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor.

The CPU 21 reads software (programs) from the RAM 22 and the ROM 23, which form main storage, and executes the software.

The RAM 22 is used as a working area for the CPU 21. The auxiliary storage device 24 may include a hard disk or a flash memory.

The communication module 25 sends and receives data through wired or wireless communication. The input device 26 may include a touch panel and/or a keyboard, and receives user operations. The input device 26 may also receive operations through voice input. The output device 27 may include a display, and outputs (displays) various sorts of information.

Software is read into hardware such as the CPU 21 and the RAM 22 to cause the communication module 25, the input device 26, and the output device 27 to operate, and cause the RAM 22 and the auxiliary storage device 24 to read and write data, under the control of the CPU 21. This achieves a series of functions in each of the appliances and devices.

The appliance 100 further includes miscellaneous mechanisms 28. The miscellaneous mechanisms 28 include mechanisms for performing actions in the appliance 100, for example a heating mechanism, a refrigerating and freezing mechanism, a cutting mechanism, and a mixing mechanism.

### (Functional Block Configuration of Terminal Device 200)

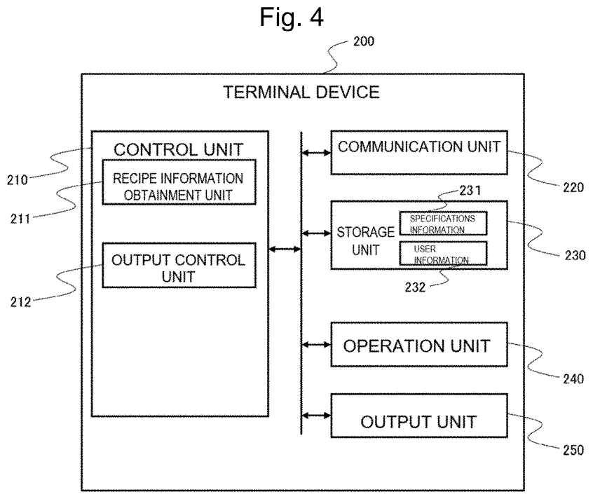

The functional block configuration of the terminal device 200 will be described. FIG. 4 is a diagram illustrating the functional block configuration of the terminal device 200 according to the embodiment.

As shown in FIG. 4, the terminal device 200 includes a control unit 210, a communication unit 220, a storage unit 230, an operation unit 240, and an output unit 250.

The control unit 210 includes the CPU 21 and controls the operations of the terminal device 200. The communication unit 220 includes the communication module 25 and performs communication over the network NW. The communication unit 220 may have a function of directly communicating with the appliance 100. The storage unit 230 includes the RAM 22, the ROM 23, and the auxiliary storage device 24, and stores various sorts of information and data.

The above control unit 210 includes a recipe information obtainment unit 211 and an output control unit 212. The recipe information obtainment unit 211 obtains recipe information from the recipe output control server 300 through the communication unit 220 in response to the user's operation on the operation unit 240. Specifically, the recipe information obtainment unit 211 obtains a quantitative HRR that includes quantitative expressions and is human-interpretable, or an MRR that is recipe information readable and interpretable by the appliance 100. This MRR may be the base of the output control information.

The recipe information obtainment unit 211 may obtain recipe information selected by the user from a recipe list displayed on the output unit 250, or may search the recipe output control server 300 to obtain recipe information that meets a search condition (such as a keyword). The recipe information obtainment unit 211 causes the output unit 250 to display the recipe information obtained. Along with the recipe information, a button for receiving a request for speech output of the recipe information (hereafter referred to as an “output control button”) may be displayed.

In response to the user operating the output control button for the above recipe information, the output control unit 212 generates a control request to control the output, such as speech output, of the recipe information. The output control unit 212 sends the control request generated to the recipe output control server 300 through the communication unit 220. The control request includes the recipe ID corresponding to the recipe information selected, and further includes the device ID of the terminal device 200 or the appliance 100 to be controlled. The output control unit 212 may also send the MRR corresponding to the recipe information selected to the recipe output control server 300.

As a response to the above control request, the output control unit 212 obtains output control information from the recipe output control server 300. According to the output control information, the output control unit 212 causes the output unit 250 to perform the output, for example speech output or object rendering output, of information in the nodes and edges of the user-designated MRR at a predetermined tempo.

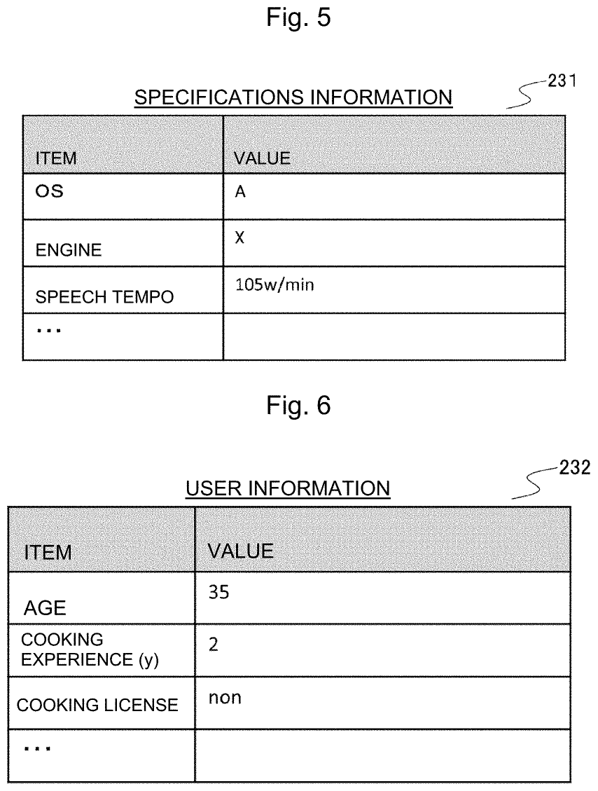

The storage unit 230 holds specifications information 231 about this terminal device 200, and user information 232. The specifications information 231 may indicate, for example, the operating system (OS), an engine such as a morphological analysis engine, a speech synthesis engine, or a rendering output engine, and the speech tempo, as shown in FIG. 5. The user information 232 may include, for example, information about the user's age and cooking skills, as shown in FIG. 6. The cooking skills may include user-reported cooking experience (whether experienced or inexperienced, the years of experience, etc.). The cooking skills may also include the user's level determined by a predetermined rule. This determination may be based on various sorts of information, for example the total number of cooking-related activities in a predetermined recipe sharing website, such as recipes posted by the user and cooking reports posted by the user about trying other users' recipes, the frequency of such cooking-related activities, and ratings received from other users. The user's level may also be determined in association with the recipe information that the user is going to use, that is, the recipe information for which recipe output control is to be performed (held in a recipe information DB 331). For example, a person with a high cooking skill and a recipe requiring an advanced cooking technique may be consistent with each other in terms of the use relationship, whereas a person with a low cooking skill is unlikely to use a recipe requiring an advanced cooking technique. The user's level may reflect such a tendency. The recipe information to be considered may include ratings and comments by users who used the recipe, in addition to the content of the recipe.

The operation unit 240 includes the input device 26 and receives the user's operations. The output unit 250 includes the output device 27 such as a display and a speaker, and displays or audibly outputs various sorts of information and data.

The output unit 250 is controlled by the output control unit 212 in the control unit 210 to control the output, such as speech output, of the recipe information according to the output control information received by the communication unit 220 from the recipe output control server 300. For example, to read the user-designated recipe information, the reading speed and the standby time before reading the next piece of information are controlled.

### (Functional Block Configuration of Recipe Output Control Server 300)

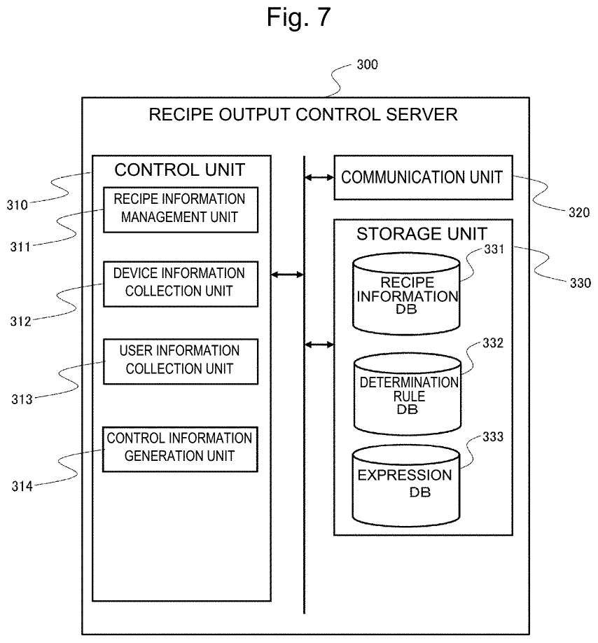

The functional block configuration of the recipe output control server 300 will be described. FIG. 7 is a diagram illustrating the functional block configuration of the recipe output control server 300 according to the embodiment.

As shown in FIG. 7, the recipe output control server 300 includes a control unit 310, a communication unit 320, and a storage unit 330.

The control unit 310 includes the CPU 21 and controls the operations of the recipe output control server 300. The communication unit 320 includes the communication module 25 and performs communication over the network NW.

The storage unit 330 includes the RAM 22, the ROM 23, and the auxiliary storage device 24, and stores various sorts of information and data. The storage unit 330 includes a recipe information DB 331, a determination rule DB 332, and an expression DB 333. These DBs will be described below in connection with the components of the control unit 310.

The control unit 310 includes a recipe information management unit 311, a device information collection unit 312, a user information collection unit 313, and a control information generation unit 314.

The recipe information management unit 311 obtains, through the communication unit 320, recipe information posted by users and stores it in the recipe information DB 331 (a recipe information storage unit).

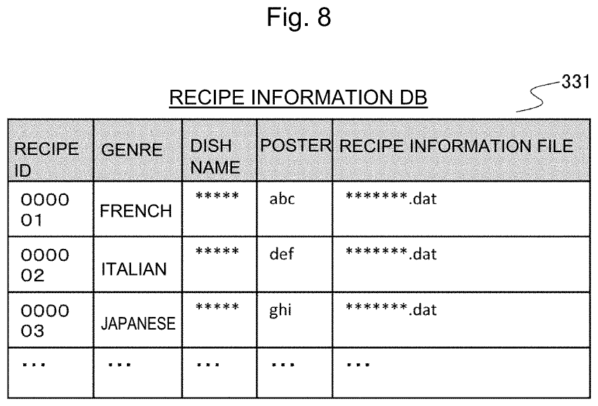

The recipe information DB 331 stores multiple pieces of recipe information, as illustrated in FIG. 8. For example, the recipe information DB 331 stores recipe information posted by users, and recipe information generated in advance by the operator of the recipe output control system 1. Each piece of recipe information may include ratings and comments provided by users who used the piece of recipe information.

The recipe information DB 331 includes recipe information in MRR form, as well as recipe information described with sets of qualitative expressions and accompanying quantitative expressions. For example, as in “fry garlic until aromatic with an IH cooker at 600 W for 3 minutes,” recipe information may be described with a set of a qualitative expression “aromatic” and accompanying quantitative expressions “600 W” and “3 minutes.” As another example, a cooking step described with a qualitative expression may have a comment provided by a user who actually made the dish, suggesting a specific setting of a cooking appliance, or may have a quantitative expression added by the operator of the recipe output control system 1.

The recipe information management unit 311 also has a function of responding to a search request from the terminal device 200 or the appliance 100 to generate, from the recipe information DB, a list of recipes that meet a search condition, and transmit the recipe list to the terminal device 200 or the appliance 100.

The device information collection unit 312 responds to, for example, pressing the above-described output control button on the appliance 100 or the terminal device 200 to collect, through the communication unit 320, specifications information 131 or 231 held in the appliance 100 or the terminal device 200.

The specifications information 131 or 231 about the appliance 100 or the terminal device 200 collected may indicate, for example, the operating system (OS), an engine such as a morphological analysis engine, a speech synthesis engine, or a rendering output engine, and the speech tempo.

The user information collection unit 313 responds to, for example, pressing the above-described output control button on the appliance 100 or the terminal device 200 to collect, through the communication unit 320, the user information 232 about the user of the terminal device 200. This user information 232 may include information such as the user's age and the user's cooking experience and cooking license (cooking skill).

Based on the specifications of the appliance 100 or the terminal device 200 and the user's attributes such as the age and the cooking skill, collected by the device information collection unit 312 and the user information collection unit 313, the control information generation unit 314 generates output control information for the recipe information designated with the above-described output control button.

In the embodiment, this output control information is generated by checking the specifications of the appliance 100 or the terminal device 200 and the user's attributes such as the age and the cooking skill, collected by the device information collection unit 312 and the user information collection unit 313, against the determination rule DB 332. An output tempo suitable for the specifications and the attributes is then determined. The output tempo may include the value of the output speed and the value of the output standby time.

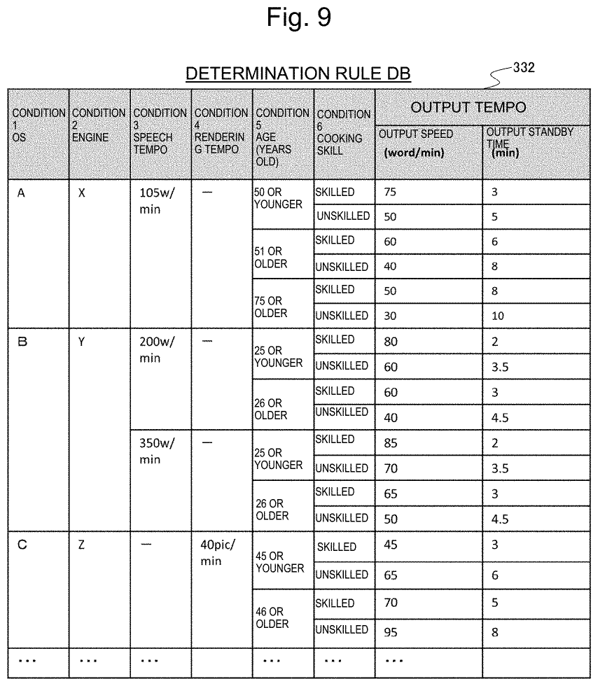

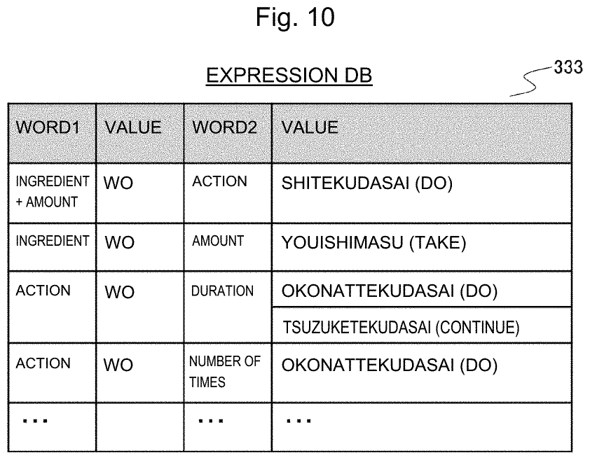

FIG. 9 illustrates an example of the determination rule DB 332. The determination rule DB 332 defines the values of output tempos suitable for different environments conditioned by the specifications of the appliance 100 or the terminal device 200 and by the user attributes.

This data structure includes records each having conditions 1 to 3 related to the device specifications, conditions 4 and 5 related to the user attributes, and the output tempo defined for the combination of these conditions. The output tempo includes the value of the output speed and the value of the output standby time.

The processing performance and its associated output tempo of the appliance 100 or the terminal device 200 (e.g., specifications of the reading speed of outputting synthesized speech, or the speed of sequentially rendering and shifting cooking steps and items as objects) may depend on the OS and an engine (such as a speech synthesis engine or a rendering output engine) of the appliance 100 or the terminal device 200. The conditions 1 to 4 in the example in FIG. 9 cover different instances of such factors. The condition 1 corresponds to the OS type; the condition 2 corresponds to the engine type, such as a speech synthesis engine or a rendering output engine; the condition 3 corresponds to the speech tempo in reading; and the condition 4 corresponds to the transition speed of rendered objects in rendering output.

Similarly, whether recipe information that is output by speech synthesis or rendering at a predetermined speed can be correctly understood as meant by the recipe often depends on attributes of the user who listens to or views the recipe, such as the user's age and cooking skill. The conditions 5 and 6 in the example in FIG. 9 cover different instances of such factors. The condition 5 corresponds to the user's age group, and the condition 6 corresponds to the user's cooking skill.

The control information generation unit 314 checks the conditions of the specifications of the appliance 100 or the terminal device 200 collected by the device information collection unit 312, i.e., the OS type, the engine type, the speech tempo, and the rendering tempo, against the conditions 1 to 4 in the determination rule DB 332. The control information generation unit 314 also checks the values of the user's age and cooking skill collected by the user information collection unit 313 against the conditions 5 and 6 in the determination rule DB 332. This enables the output tempo, including the output speed and the output standby time, to be determined for the recipe information designated with the above-described output control button.

Based on the MRR corresponding to the user-designated recipe information and based on the expression DB 333, the control information generation unit 314 determines values to be added to the content of output, for example speech output, of the MRR. For example, “wo” is determined as a value to be added between words “half onion” in an ingredient node and a word “cut” in an edge connected to this ingredient node, and “shitekudasai” is determined as a value to be added after “cut.” This processing is exhaustively performed throughout the structure of the nodes and edges in the MRR.

The control information generation unit 314 transmits, as output control information, the speech output content determined based on the expression DB 333 as above and the output tempo information determined as above to the appliance 100 and/or terminal device 200.

The control information generation unit 314 sets the values of the output tempo determined as above in the fields of the output speed and the output standby time in the nodes and edges in the MRR, and transmits the MRR to the appliance 100. Ingredients and their transitional states that may correspond to the nodes in the MRR, and actions that may correspond to the edges in the MRR, are stored in advance as graph information (not shown) in the storage unit 330. The control information generation unit 314 refers to this graph information to make settings in the MRR.

### (Functional Block Configuration of Appliance 100)

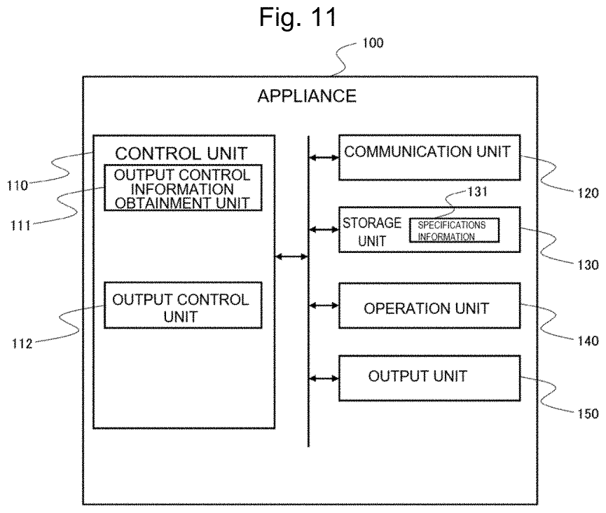

Now, the functional block configuration of the appliance 100 will be described. FIG. 11 is a diagram illustrating the functional block configuration of the appliance 100 according to the embodiment.

As shown in FIG. 11, the appliance 100 includes a control unit 110, a communication unit 120, a storage unit 130, an operation unit 140, and an output unit 150.

The control unit 110 includes the CPU 21 and controls the operations of the appliance 100. The communication unit 120 includes the communication module 25 and performs communication over the network NW. The communication unit 120 may have a function of directly communicating with the terminal device 200. The storage unit 130 includes the RAM 22, the ROM 23, and the auxiliary storage device 24, and stores various sorts of information and data. The operation unit 140 includes the input device 26 and receives user operations. The operation unit 140 has physical buttons or software buttons for receiving actions (processing). The output unit 150 is controlled by an output control unit 112 in the control unit 110 to output recipe information received by the communication unit 120 from the recipe output control server 300, and to control the output, such as speech output, of the recipe information according to the above-described output control information obtained by an output control information obtainment unit 111. For example, to read user-designated recipe information, the reading speed and the standby time before reading the next piece of information are controlled.

Among the above components, the control unit 110 includes the output control information obtainment unit 111 and the output control unit 112.

The output control information obtainment unit 111 transmits the specifications information 131 held in the storage unit 130 to the device information collection unit 312 in response to a request from the recipe output control server 300. After transmitting the specifications information 131, the output control information obtainment unit 111 obtains, through the communication unit 120, an MRR and its output control information transmitted from the recipe output control server 300.

After the output control information obtainment unit 111 obtains the MRR and the output control information, the output control unit 112 starts output control according to the output control information for speech output or rendering output of the MRR. The output control unit 112 may start speech output or rendering output in response to the user operating the operation unit 140 (e.g., an output start button).

### (Exemplary Operations According to Embodiment)

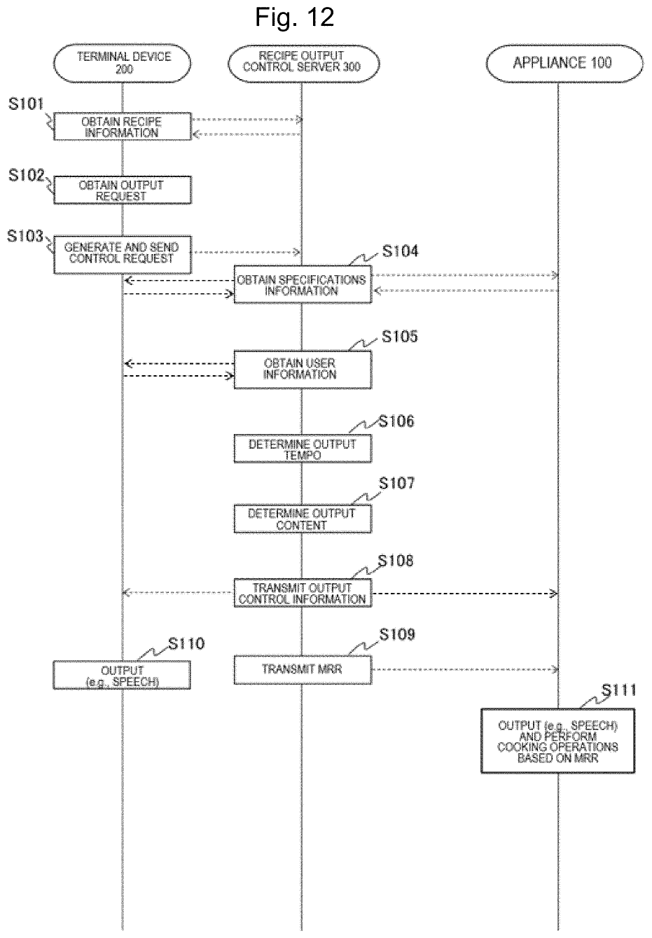

An example of operations of the recipe output control system 1 in the embodiment will be described. FIG. 12 is a diagram illustrating exemplary operations of the recipe output control system 1.

As shown in FIG. 12, at step S101, the terminal device 200 responds to the user's operation on the operation unit 240 to obtain recipe information from the recipe output control server 300 through the communication unit 220.

At step S102, the terminal device 200 displays the obtained recipe information on the output unit 250 and receives, through the operation unit 240, a request for speech output or rendering output of the recipe information. It is assumed here that a speech output request is received.

At step S103, in response to the above speech output request, the terminal device 200 generates a control request for controlling the speech output of the recipe information and sends the control request to the recipe output control server 300 through the communication unit 220. The control request includes the recipe ID corresponding to the recipe information selected, and further includes the device ID of the terminal device 200 or the appliance 100 to be controlled.

At step S104, the recipe output control server 300 receives the above speech output request from the terminal device 200 and collects, through the communication unit 320, the specifications information 231 held by the terminal device 200. If the speech output request is received from the appliance 100, the specifications information 131 held by the appliance 100 is collected.

At step S105, the recipe output control server 300 collects, through the communication unit 320, the user information 232 held by the terminal device 200.

At step S106, the recipe output control server 300 checks the specifications information 231 about the terminal device 200 and the user information 232 collected at above S104 and S105 against the determination rule DB 332. The recipe output control server 300 thus determines the output tempo that matches the conditions of the specifications information 231 and the user information 232.

At step S107, the recipe output control server 300 uses the recipe ID indicated by the above speech output request as a key to identify a corresponding MRR in the recipe information DB 331. Based on this MRR and the expression DB 333, the recipe output control server 300 determines the speech output content of the MRR.

At step S108, the recipe output control server 300 transmits, as output control information, the speech output content determined at above S107 and the output tempo information determined as above to the terminal device 200 (or the appliance 100).

At step S109, the recipe output control server 300 sets the values of the output tempo determined as above in the fields of the output speed and the output standby time in the nodes and edges in the MRR, and transmits the MRR to the appliance 100.

At step S110, according to the speech output content and the output tempo of the MRR transmitted from the recipe output control server 300, the terminal device 200 outputs, for example reads, information in the nodes and edges of the MRR through the output unit 250 at the tempo determined.

At step S111, the appliance 100 receives the MRR (in which the output control information is set) transmitted from the recipe output control server 300. The appliance 100 controls the speech output of the MRR according to the output control information, and performs cooking operations according to the MRR.

As described above, the recipe output control system 1 refers to specifications of a device, such as an oven, a microwave oven, a refrigerator, or a mobile terminal like a smartphone, and attributes of the user of the device, such as the user's age and cooking skill, thereby enabling a recipe to be output at a tempo suitable for the user's understanding.

This advantage is achieved by addressing the following problems. Conventional recipes are usually written to be viewed in normal text form. Outputting such recipes in speech, VR, or AR form often does not well match the human perception, thinking speed, and senses, thus preventing the user's clear understanding of the content of the recipes. This is further worsened by attributes of a device that outputs recipes, or attributes of the user of the device. The recipe output control system in the embodiment is configured to solve these problems.

### Other Embodiments>

While the embodiment has been described above, it should be understood that the description and the drawings that form part of the present disclosure do not limit the invention. Various alternative embodiments, implementations, and operational techniques will become apparent to those skilled in the art from the present disclosure.

The above embodiment has illustrated the appliance 100 and the terminal device 200 that are separate from each other. However, the appliance 100 and the terminal device 200 may be operated by integrating the functions and information in one of the appliance 100 and the terminal device 200 into the other. The functions and information in the recipe output control server 300 may also be implemented in the appliance 100 or the terminal device 200.

A program causing a computer to perform processes of the recipe output control system 1 may be provided. The program may be recorded on a computer-readable medium, which may be used to install the program into the computer. The computer-readable medium having the program recorded thereon may be a non-transitory recording medium, which may be, but not limited to, a recording medium such as a CD-ROM or a DVD-ROM, for example.

### (Description of Advantageous Effects)

The recipe output control system according to the embodiment addresses the needs of, for example, users who are busy with childcare or other housework or visually impaired or hearing-impaired users, desiring to know recipes in the form of speech, virtual reality (VR), or augmented reality (AR). To this end, the system can enable the speech output or rendering output of recipes in readily understandable form that matches the human perception, thinking speed, and senses. In particular, recipes are read or rendered at a tempo that facilitates the understanding by aged users or unskilled users having a lower information recognition speed or efficiency than young people or than people experienced at cooking. This ensures the users' understanding of the recipe content.

Thus, the recipe output control system according to the embodiment appropriately addresses different devices used by different users, or addresses different users having different levels of understanding due to their cooking skill or age. This enables the output, such as speech output, of recipe information in a manner (e.g., at a tempo) that facilitates each user's understanding.

The embodiment can be implemented in various other forms and allows various eliminations, substitutions, and modifications to be made without departing from the spirit of the invention. The embodiment and its variations are within the scope and spirit of the disclosure, as well as within the scope of the features set forth in the claims and their equivalents.

Aspects of the present disclosure can also be realized by a computer of a system or apparatus that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments.

For this purpose, the program is provided to the computer for example via a network or from a recording medium of various types serving as the memory device (e.g., a non-transitory computer-readable medium). While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

### REFERENCE SIGNS LIST

1: recipe output control system

21: CPU

22: RAM

23: ROM

24: auxiliary storage device

25: communication module

26: input device

27: output device

28: mechanisms

100: appliance

110: control unit

111: output control information obtainment unit

112: output control unit

120: communication unit

130: storage unit

131: specifications information

140: operation unit

150: output unit

200: terminal device

210: control unit

211: recipe information obtainment unit

212: output control unit

220: communication unit

230: storage unit

231: specifications information

232: user information

240: operation unit

250: output unit

300: recipe output control server

310: control unit

311: recipe information management unit

312: device information collection unit

313: user information collection unit

314: control information generation unit

320: communication unit

330: storage unit

331: recipe information DB

332: determination rule DB

333: expression DB

1. A server device comprising:
a memory that stores recipe information; and
circuitry configured to
transmit, via a network, the recipe information to a terminal device;
receive, via the network, user attribute information regarding an attribute of a user of the terminal device;
receive, via the network, information regarding an information output mode available by the terminal device or a cooking appliance device; and
perform control for outputting the recipe information by at least one of the terminal device or the cooking appliance device, based on the received information regarding the information output mode and the received user attribute information, the recipe information being output, by the cooking appliance device or the terminal device, in an output mode that matches the attribute of the user indicated by the user attribute information.

2. The server device according to claim 1, wherein
the circuitry is configured to transmit, to the terminal device, output information to be output by the terminal device, in the output mode that matches the user attribute of the user indicated by the user attribute information.

3. The server device according to claim 1, wherein
the circuitry is configured to transmit, to the cooking appliance device, output information to be output by the cooking appliance device, in the output mode that matches the user attribute of the user indicated by the user attribute information.

4. The server device according to claim 1, wherein
the circuitry is configured to generate output control information including information output tempo as the output mode of the recipe information, based on specification information of the cooking appliance device and based on information recognition ability of the user indicated by the user attribute information.

5. The server device according to claim 4, wherein
the circuitry is configured to
transmit, as the recipe information, quantitative recipe information represented as a graph including nodes and edges between the nodes, each of the nodes indicating at least one of a plurality of ingredients and a dish to be made with the plurality of ingredients, and each of the edges indicating information about state transition of the plurality of ingredients, and
determine, as the information of the output tempo in the output control information, an output speed of information in each node and each edge, and an output standby time between the node and the edge.

6. The server device according to claim 4, wherein
the circuitry is further configured to
obtain the specification information of the cooking appliance device from the cooking appliance device, and
perform control for outputting the recipe information by the cooking appliance device, based on the information output tempo according to the specification information and based on the information recognition ability according to at least one of the user's age or the user's cooking skill indicated by the user attribute information.

7. The server device according to claim 6, wherein
the recipe information is output by the cooking appliance device by speech output with a speech tempo, the speech tempo being determined based on the information output tempo in the output control information.

8. The server device according to claim 6, wherein
the recipe information is output by the cooking appliance device by display output with a display tempo, the display tempo being determined based on the information output tempo in the output control information, in association with the information recognition ability including at least one of the user's age or the user's cooking skill.

9. The server device according to claim 1, wherein
the circuitry is configured to
receive, via the network, a request for the recipe information from the terminal device;
transmit, via the network, the recipe information to the terminal device in response to receiving the request.

10. The server device according to claim 9, wherein
the recipe information is output by the terminal device by speech output according to the determined output tempo based on the output control information.

11. The server device according to claim 4, wherein
the cooking appliance device is at least one of a refrigerator, a microwave oven, an oven, an induction cooker, a toaster oven, a food processor, a mixer, a rice cooker, an electric pot, an electric fryer, an electric steamer, a noodle maker, a kitchen scale, a cooking robot, a gas cooker, and lighting equipment.

12. The server device according to claim 6, wherein
the circuitry is configured to further determine the user's level as the user's cooking skill indicated by the user attribute information, based on at least one of a report of the user's cooking experience, a total number of cooking-related activities in a predetermined recipe sharing website, a frequency of cooking-related activities, and ratings received from other users.

13. The server device according to claim 6, wherein
the circuitry is configured to determine the output tempo in accordance with a determination rule, the determination rule being a combination of at least two of a plurality of conditions, including a first condition of Operating System (OS), a second condition of engines such as a morphological analysis engine, a speech synthesis engine, or a rendering output engine, a third condition of a speech tempo of the terminal device or the cooking appliance device, a fourth condition of a display tempo, a fifth condition of the user's age, and a sixth condition of the user's cooking skill.

14. The server device according to claim 13, wherein
the circuitry is configured to determine a first output tempo as the output tempo, when the use's age is equal or over a predetermined age and the user's cooking skill is determined as unskilled, based on the fifth condition and the sixth condition of the determination rule.

15. An electronic device comprising:
a memory and at least one processor configured to function as:
an obtainment unit that obtains recipe information and a recipe output mode, the recipe output mode being based on output information about an information output mode of the electronic device and based on user attribute information about a user of the electronic device,
the recipe information being output according to the recipe output mode.

16. A method for controlling a server device, comprising:
transmitting, via a network, recipe information to a terminal device;
receiving, via the network, user attribute information regarding an attribute of a user of the terminal device;
receiving, via the network, information regarding an information output mode available by the terminal device or a cooking appliance device; and
performing control for outputting the recipe information by at least one of the terminal device or the cooking appliance device, based on the received information regarding the information output mode and the received user attribute information, the recipe information being output, by the cooking appliance device or the terminal device, in an output mode that matches the attribute of the user indicated by the user attribute information.

17. A non-transitory computer-readable recording medium that stores a program which causes a computer to execute a method for controlling a server device, the method comprising:
transmitting, via a network, recipe information to a terminal device;
receiving, via the network, user attribute information regarding an attribute of a user of the terminal device;
receiving, via the network, information regarding an information output mode available by the terminal device or a cooking appliance device; and
performing control for outputting the recipe information by at least one of the terminal device or the cooking appliance device, based on the received information regarding the information output mode and the received user attribute information, the recipe information being output, by the cooking appliance device or the terminal device, in an output mode that matches the attribute of the user indicated by the user attribute information.
